(19) United States
(12) Patent Application Publication
(10) Pub. No.: US 2011/0259499 A1
(43) Pub. Date: Oct. 27, 2011

(54) TIRE HAVING SELF-SEALING PROPERTY

(76) Inventor: CHUN-FU KUO, Taichung Hsien (TW)

(21) Appl. No.: 12/765,752

(22) Filed: Apr. 22, 2010

(51) Int. Cl. B60C 19/12

(52) U.S. Cl. 152/504

(57) ABSTRACT

The tire of the present invention has self-sealing property. The tire has an inner tire surface, which is formed with a plurality of protrusions. The protrusions are circumferentially distributed over the inner tire surface. A sealing gel layer is disposed on the inner tire surface and at least partially covers the protrusions to form a composite structure. Thereby, the protrusions can spread the force applied on the sealing gel layer while the tire is rotated rapidly. As such, the problems that the sealing gel layer is concentrated or delaminated can be prohibited.

### BACKGROUND OF THE INVENTION

1. Field of the Invention

The present invention relates to a tire, and more particularly to a tire having self-sealing property.

2. Description of the Prior Art

Conventional self-sealing tires have sealing gel coated on their inner tire surfaces. As the tire is punctured, the sealing gel can fill the hole to prohibit the tire from deflation.

Some self-sealing tires have sealant chambers to receive the sealing gel therein, as disclosed in U.S. Pat. No. 7,316,253. The inner tire surface is formed with the sealant chamber prior to the filling of the sealing gel. However, the forming process of the sealant chamber and the filling of the sealing gel are both complicated. Thus such tire having sealant chamber is hard to be produced.

Other self-sealing tires have their inner tire surfaces directly coated with the sealing gel, as disclosed in U.S. Pat. No. 4,359,078. Nevertheless, the balance loss of the tire is commonly seen when the tire rotates quickly, manly because the centrifugal force and the high temperature environment cause the sealing gel to ununiformly distribute over the inner tire surface. What's worse, the sealing gel might delaminate from the inner tire surface, which seriously affects the driving safety.

The present invention is, therefore, arisen to obviate or at least mitigate the above mentioned disadvantages.

### SUMMARY OF THE INVENTION

The main object of the present invention is to provide a self-sealing tire having a composite structure to prohibit the tire from the risk of sealing gel concentration or delamination.

To achieve the above and other objects, the tire of the present invention has an inner tire surface, which is formed with a plurality of protrusions. The protrusions are circumferentially distributed over the inner tire surface. A sealing gel layer is disposed on the inner tire surface and at least partially covers the protrusions to form a composite structure.

Thereby, the protrusions can spread the force applied on the sealing gel layer while the tire is rotated rapidly. As such, the problems that the sealing gel layer is concentrated or delaminated can be prohibited.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective drawing showing a tire of the present invention;

FIG. 2 is a perspective drawing showing a tire of the present invention before the disposing of the sealing gel layer;

FIG. 3 is a schematic drawing showing a tire of the present invention;

FIG. 3A is a partial enlargement of FIG. 3;

FIG. 4 is a schematic drawing showing the process of disposing the sealing gel layer.

### DETAILED DESCRIPTION OF THE PREFERRED EMBODIMENTS

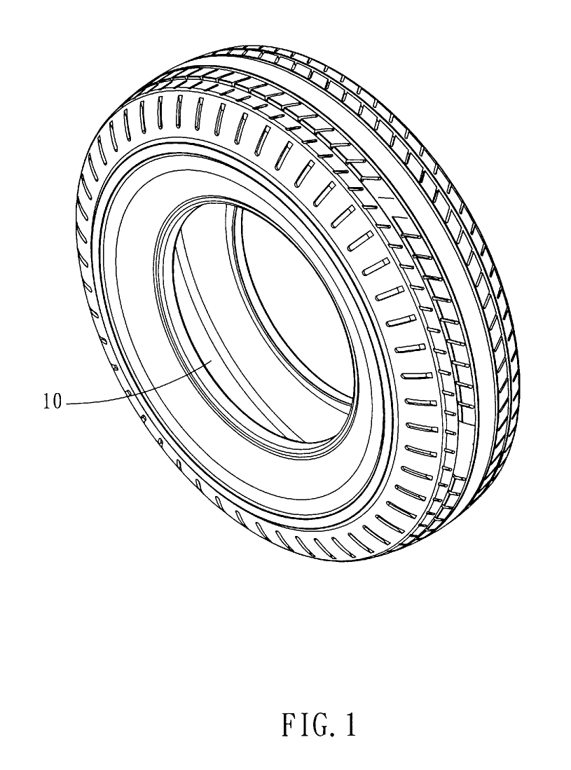

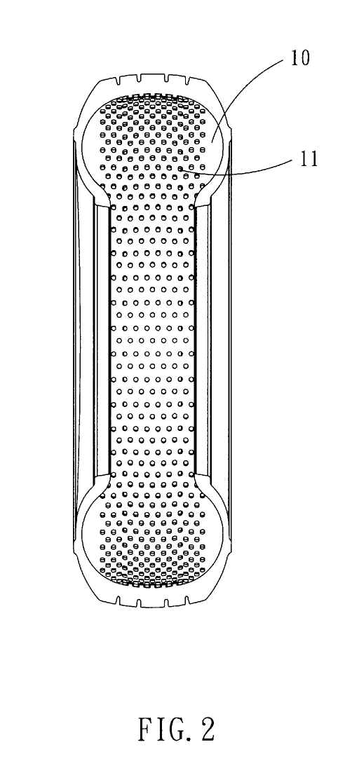

Please refer to FIG. 1. A self-sealing tire of the present invention has an inner tire surface 10, which is formed with a plurality of protrusions 11, as shown in FIG. 2. The protrusions 11 are circumferentially distributed over the inner tire surface 10. Preferably, the protrusions 11 are circumferentially and uniformly distributed within the width of the inner tire surface 10. The protrusions 11 are preferably arranged to form a matrix structure, so as to balance the mass of the tire. The protrusions 11 can be cylinders or polygonal columns, and the protrusions 11 are preferably integrally formed on the inner tire surface 10.

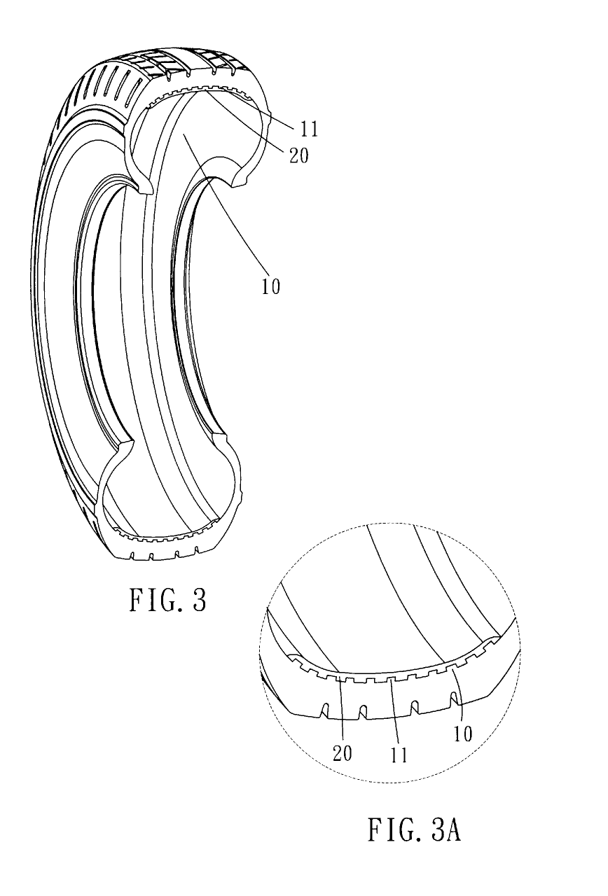

Please refer to FIG. 3 and FIG. 3A. In the present invention, a sealing gel layer 20 is disposed on the inner tire surface 10. The sealing gel layer 20 at least partially covers the protrusions 11 to form a composite structure. In the present embodiment, the sealing gel layer 20 completely covers the protrusions 11, i.e. the thickness of the sealing gel layer 20 is bigger than the length of the protrusions 11. Nevertheless, the protrusions 11 can still be partially protrusive from the sealing gel layer 20 in other possible embodiments of the present invention.

The sealing gel layer 20 is substantially unflowable and has high viscosity, and the sealing gel layer 20 can endure 120 degree Celsius without being melted. As the tire is punctured by an object, the sealing gel will stick onto the object, and the sealing gel can be further pulled in correspondence to the movement of the object, so as to further fill in the hole through which the object punctures. As such, the tire of the present invention has self-sealing property to prevent deflation while punctured.

In order to reduce the weight of the tire, the sealing gel layer 20 may be a foaming layer, and the foaming layer has a plurality of close-celled bubbles. As a result, the sealing gel layer 20 can be light-weighted, and the close-celled bubbles, rather than open-celled bubbles, can still ensure the self-sealing property of the tire.

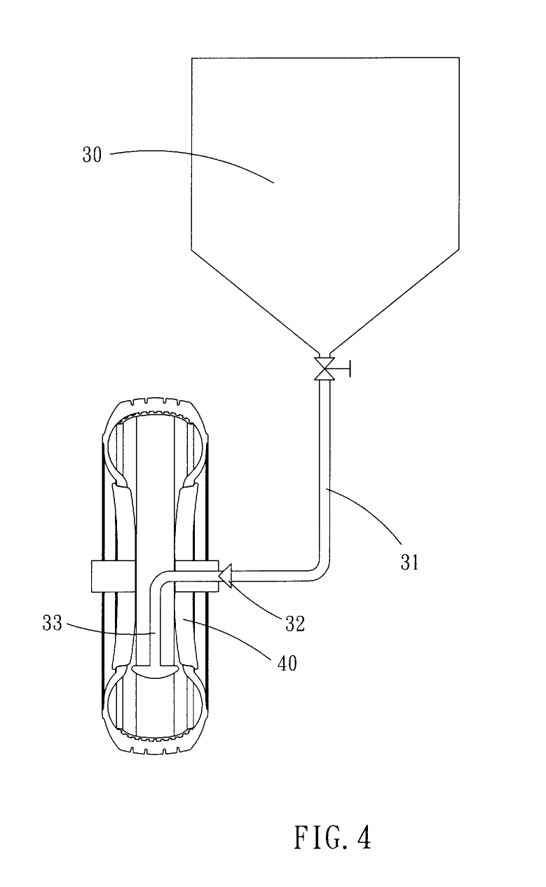

Please refer to FIG. 4. During a process of disposing the sealing gel layer 20, the tire is vertically or horizontally placed on a centrifugal machine, which can drive the tire to quickly rotate about its axis in situ. In a preferred embodiment of the present invention, the centrifugal machine includes a tire positioner 40 and a rotating equipment. The tire positioner 40 includes, for instance, two positioning disc coaxially installed in two lateral openings of the tire. The rotating equipment provides the force to drive the tire positioner 40 and the tire to rotate. A blending device 30 is filled with materials of the sealing gel layer, and the blending device is adapted to blend the materials uniformly. The blending device 30 has a detachable connection pipe 31. The connection pipe 31 has an input opening 32 close to a center of the tire. A storage space 33 is defined between the input opening 32 and the inner tire surface 10 and is adapted to receive the blended materials. When the tire is rotated by the centrifugal machine, the air near the storage space 33 flows very fast with respect to the storage space, thus a negative pressure is generated to suck the blended materials out of the storage space 33. Thus the blended materials are coated on the inner tire surface 10. The centrifugal force will further cause the materials coated on the inner tire surface 10 to circumferentially spread on the inner tire surface 10 until the materials are spread within a width of the inner tire surface 10 uniformly to form the sealing gel layer 20. Preferably, the above mentioned process is proceeded at room temperature.

In a preferred embodiment of the present embodiment, the sealing gel layer 20 is made of polyurethane, and the materials thereof include diisocyanate and polyol. The materials are still flowable in the blending device 30. Once the materials are coated on the inner tire surface 10, the diisocyanate and the polyol are gradually reacted to generate the polyurethane until the materials are spread within a width of the inner tire surface uniformly and become unflowable to form the sealing gel layer 20. The materials can be further blended with air, such as nitrogen, or foaming agent in the blending device 30 in order to form a foaming layer on the inner tire surface 10.

The protrusions on the inner tire surface not merely increase the contact area which contacts the sealing gel layer, but also forms a composite structure with the sealing gel layer. As such, the protrusions can spread the force applied on the sealing gel layer when the tire rotates rapidly, so as to prevent the sealing gel layer from mass concentration or delamination. Therefore, the safety performance of the tire of the present invention can be significantly elevated.

What is claimed is:

1. A tire, having an inner tire surface, the inner tire surface being formed with a plurality of protrusions, the protrusions being circumferentially distributed over the inner tire surface, a sealing gel layer being disposed on the inner tire surface, the sealing gel layer at least partially covering the protrusions to form a composite structure.

2. The tire of claim 1, wherein during a process of disposing the sealing gel layer, the tire is placed on a centrifugal machine, a blending device is filled with materials of the sealing gel layer, the blending device has a connection pipe, the connecting pipe has an input opening close to a center of the tire, a storage space is defined between the input opening and the inner tire surface, the storage space is adapted to receive the blended materials, when the tire is rotated by the centrifugal machine, the blended materials in the storage space are sucked and then coated on the inner tire surface, and the centrifugal force causes the materials coated on the inner tire surface to circumferentially spread on the inner tire surface until the materials are spread within a width of the inner tire surface uniformly to form the sealing gel layer.

3. The tire of claim 2, wherein the tire is vertically placed on the centrifugal machine.

4. The tire of claim 2, wherein the tire is horizontally placed on the centrifugal machine.

5. The tire of claim 2, wherein the sealing gel layer is made of polyurethane, the materials of the sealing gel layer include diisocyanate and polyol, when the materials are sucked and coated on the inner tire surface, the diisocyanate and the polyol are gradually reacted to generate the polyurethane.

6. The tire of claim 1, wherein the sealing gel layer is substantially unflowable and has high viscosity, the sealing gel layer can endure 120 degree Celsius without being melted.

7. The tire of claim 1, wherein the sealing gel layer is a foaming layer, the foaming layer has a plurality of close-celled bubbles.

8. The tire of claim 2, wherein the process of disposing the sealing gel layer is proceeded at room temperature.

9. The tire of claim 1, wherein the sealing gel layer completely covers the protrusions.

10. The tire of claim 1, wherein the protrusions are circumferentially and uniformly distributed within the width of the inner tire surface.
